(19) United States
(12) Patent Application Publication
(10) Pub. No.: US 2012/0273359 A1
(43) Pub. Date: Nov. 1, 2012

(54) FLOW-THROUGH ELECTRODE CAPACITIVE DESALINATION

(76) Inventors: Matthew E. Suss, Stanford, CA (US); Theodore F. Baumann, Discovery Bay, CA (US); William L. Bourcier, Livermore, CA (US); Christopher Spadaccini, Oakland, CA (US); Michael Stadermann, Pleasanton, CA (US); Klint Rose, Alviso, CA (US); Juan G. Santiago, Stanford, CA (US)

(21) Appl. No.: 13/405,088

(22) Filed: Feb. 24, 2012

Related U.S. Application Data
(60) Provisional application No. 61/480,752, filed on Apr. 29, 2011.

(51) Int. Cl. B03C 9/00

(52) U.S. Cl. 204/554; 204/674

(57) ABSTRACT

An electrode “flow-through” capacitive desalination system wherein feed water is pumped through the pores of a pair of monolithic porous electrodes separated by an ultrathin non-conducting porous film. The pair of monolithic porous electrodes are porous conductors made of a material such as activated carbon aerogel. The feed water flows through the electrodes and the spacing between electrodes is on the order 10 microns.

### CROSS-REFERENCE TO RELATED APPLICATIONS

The present application claims benefit under 35 U.S.C. §119(e) of U.S. Provisional Patent Application No. 61/480,752 filed Apr. 29, 2011 entitled “flow-through electrode capacitive desalination,” the disclosure of which is hereby incorporated by reference in its entirety for all purposes.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory and pursuant to National Science Foundation (NSF) contract number 09676000.

### BACKGROUND

1. Field of Endeavor

The present invention relates to capacitive deionization and more particularly to flow through capacitive deionization.

2. State of Technology

State of technology information is provided in United States Published Patent Application No. 2011/0247937 for a method and apparatus for permeating flow desalination. The Published Patent Application No. 2011/0247937 includes the following state of technology information:

Desalination refers to any process that removes dissolved minerals (including but not limited to salt) from seawater, brackish water, or treated wastewater to obtain fresh water for human consumption, irrigation or other industrial applications. Desalination of seawater is common in regions of water scarcity such as the Middle-East, and the Caribbean islands. In other parts of the world, such as the United States, North Africa, Singapore and China, desalination is mostly restricted to brackish water treatment. Desalination is also extensively used in ships, submarines, islands and homes in rural areas where freshwater distribution systems are insufficient to meet the daily needs. The latter also extends to countries where severe lack of infrastructure causes acute water shortfalls despite ample amount of precipitation.

The growing water crisis ranks alongside the problems of shortage of viable energy resources and global warming in terms of its frightening global spread and magnitude. The World Water Development Report by the United Nations delivers the grim prognosis that by the middle of this century, more than 50 nations, constituting a population between 2 to 7 billion, will face a water crisis. Currently, about 7500 desalination plants world-wide already strive to meet current water demands. However, their cumulative contribution is only about 1% of the world's water use. In other words, although the requirement for desalination has been well documented for the past several decades, desalination provides only a tiny fraction of the world's current freshwater needs. The contribution by desalination is so miniscule because the current state of the desalination technology does not support extensive use. One of the primary reasons for this deficiency is the cost. The prohibitive costs associated with the currently-prevailing membrane-based and thermal desalination technologies heavily discourages potential users, unless the local distribution of energy and water resources is significantly skewed in favor of the former, as in the Middle-East. Although membrane related research has helped improve the situation somewhat, particularly for potable water, the greater share of the market, for industrial and agricultural uses, cannot be satisfied with the energy requirements inherent in the processes. The large-scale desalination market is dominated by reverse osmosis (RO), a membrane-based process, and multi-stage flash (MSF), a distillation process. Another process that has been in vogue, since the 1970s, especially for brackish water desalination, is electrodialysis reversal (EDR), a membrane-based process.

In recent years, capacitive deionization (CDI) has been proposed as a solution to some of the crucial issues that have plagued the previous desalination processes, such as energy cost and membrane fouling. The CDI process involves the flow of saline water through, that is between, a pair of high surface area, porous electrodes (e.g. activated carbon cloth) across which a small voltage is applied. During the flow, the ions in the saline water move towards respective electrodes, depending upon the polarity of the ions. Each electrode is able to electrostatically adsorb the ions in a reversible manner. During this charging process, capacitive current flows in the external circuit connecting the electrodes. Consequently, the water flowing out of the system is de-ionized. Once the capacitor, formed by the electrodes, external circuit, and water, is fully charged, the ions are regenerated by shorting the electrodes (or by applying a reverse polarity), thereby flushing the ions absorbed during the charging process by means of waste water through the same flow path. This process is herein referred to as an axial flow discharge process (AFD). The CDI process has been reported to provide nearly an order of magnitude advantage in power requirements over the membrane processes and even the EDR process. This is supported, for example, by tables 2 and 3 of, “Effect of Permation on Discharge Characteristics of Capacitive Deionization Process” by Ishan Barman, submitted to the department of mechanical engineering in partial fulfillment of the requirements or the degree of master of science in mechanical engineering at the Massachusetts Institute of Technology, June 2007, which is hereby incorporated by reference in its entirety.

Although the capacitive process has shown some promise, it is yet to be fully implemented in an industrial setup. The most significant obstacle to full-scale implementation of capacitive deionization systems is the low water recovery ratio characteristic of existing CDI systems. Water recovery ratio is defined as the amount of desalinated water obtained to the total amount of input water. For a given throughput of a desalination plant/process, the water recovery ratio and the power consumption per unit volume of water desalinated provide the two most significant metrics for judging the effectiveness of the plant/process. The power consumption of a desalination process, and attendant cost, is dependent upon, among other factors, the process' water recovery. The costs of pumping and pre- and post-treatment of water, which are greater for low water recovery ratio processes, added to the rising costs of surface water, makes maximizing the recovery ratio .alpha. priority. Additionally, because aquifer withdrawals typically surpass aquifer recharge, with resulting drops in water tables, the maximization of water recovery ratio is even more important. In a conventional capacitive deionization process, the discharge typically takes at least half the time required for charging. This has led to typically poor water recovery ratios with the maximum reported being around 0.5-0.6 (for brackish water desalination), as disclosed, for example, in Capacitive Desalination Technology An Alternative Desalination Solution,” Desalination, 183, 2-340, 2005, Welgemoed, T. J. Schutte, C. F., and “Desalination Of A Thermal Power Plant Wastewater By Membrane Capacitive Deionization,” Desalination 196, 125-134, 2006, Lee, J-B., Park K-K., Eum, H-M., Lee, C-W., which are hereby incorporated by reference in their entirety. By way of comparison, the corresponding recovery ratios for the reverse osmosis and electrodialysis reversal processes for brackish water desalination typically exceed 0.85-0.94. See, for example, “High Water Recovery With Electrodialysis Reversal,” Proceedings American Water Works Association Membrane Conference, Baltimore, Md., Aug. 1-4 1993, by Allison, R. P., which is hereby incorporated by reference in its entirety. In addition, the available energy during a conventional capacitive deionization process cycle is not fully utilized, because the system is really operational in two-thirds of the total cycle time one third of the time the system is recharging by flushing accumulated ions from the system's electrodes. Consequently, expensive energy capacity is wasted in a conventional capacitive deionization process. Furthermore, the low water recovery ratio associated with a conventional capacitive deionization process constrains the range of salinity of input water the process can be used for.

Capacitive deionization involves a process whereby water from which ions are to be removed (referred to hereinafter as “feed water”) flows between electrodes to which a potential difference is applied. As the feed water flows between the electrodes, ions within the water are attracted to respective electrodes: negative ions to the positively charged electrode and positive ions to the negatively charged electrode. More ions are removed from the water as it traverses the path between the electrodes, rendering the water purer and purer along the path. At some point, the electrodes between which the water passes become saturated with ions that have been removed from the feed water and adhere to the electrodes. When the electrodes are saturated, the ions adhering to the electrodes are flushed, thereby producing some water with a much higher concentration of ions. The deionized, or “purified,” water and brackish, or “concentrated,” water are separated; the purified water destined for use in any of a myriad of applications, including agricultural, drinking, industrial, the concentrated water for disposal. Some components of the concentrated water, such as Sodium salt, may find application as well. Additionally, the components of concentrated water may contain precious metals which could be of further use in different applications. This method could thus be employed not only for desalinating brackish or sea water but also for purifying useful metals and such like.

The point at which the electrodes are flushed may be predetermined, on the basis of a time cycle, for example, or ion concentrations may be sensed and used by a controller to determine the time at which to begin and end an electrode-flushing process. In accordance with the principles of the present invention, solvent drag is employed to accelerate the flushing process and to thereby reduce the percentage of time devoted to recharging the system. A smaller percentage of time devoted to recharging the system yields a higher water recovery ratio, a key consideration in desalination systems.

In an illustrative embodiment, feed water is introduced to a channel with electrodes on either side. In this embodiment, the electrodes include a high specific surface area material. Examples of suitable materials include inert carbon-based solids such as an aerogel, porous woven carbon fiber electrodes, nanotubes or other nanostructure. During the desalination process the electrodes will be charged to attract ions to the electrodes. The ions are adsorbed by the high specific surface area material and, eventually, the electrodes become less and less effective at removing ions from the feed water. At a chosen time, which may be predetermined, based upon a predetermined cycle time, or which may be determined by sensing the ion concentration of water purified by the system, the electrodes are recharged using a combination of mechanisms including diffusion and solvent drag. Solvent drag provides for much more effective recharging of the electrodes than conventional diffusion-based recharging.

There is a significant need for the design and development of a process, which, while retaining the energy efficiency of the capacitive deionization process, is able to achieve higher concentration reductions of the feed stream per charge, and able to do so in a fast manner (in seconds). For example, achieving a concentration reduction of 50 mM or more per charge, where removal of ions would be completed within seconds, would open up application space for CD as an energy efficient, membrane-less technology in both saline aquifer desalination and, using several staged cells, for sea water desalination. It would be desirable to achieve the above goals without the use of additional membranes, spacers and such elements that increase power consumption and pressure drops reducing the efficacy of the process. The developed system should be amenable to easy fabrication and assembly.

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides an electrode “Flow-Through” capacitive desalination system. Applicants “Flow-Through” capacitive desalination system is contrasted with the prior art “Flow Between” capacitive desalination systems. FIG. 1 illustrates the prior art “Flow Between” capacitive desalination system wherein feed water flows through the gap between electrodes to which a potential difference is applied. FIG. 2 illustrates Applicants' “Flow-Through” system 200 wherein electrodes are located so that a flow of feed water flows through the electrodes. A porous, solid separator is located between the pair of electrodes. Each of the electrodes in the pair includes pores through which the flow of feed water flows.

Applicants' electrode “flow-through” capacitive desalination system involves flowing feed water through the pores of a pair of monolithic porous electrodes separated by an ultrathin non-conducting porous film. By flowing the feed water through the electrode and reducing the spacing between electrodes to order 10 microns, Applicants' system significantly lowers cell electrical resistance and energy requirements, increases desalination efficiency (target salt stored per electron transferred), and enables faster charging and discharging. Applicants' system could allow for significant energy and infrastructure savings over traditional flow between systems and other water desalination techniques. Applicants have developed a technique of performing capacitive deionization (CDI), utilizing porous conductors such as activated carbon aerogels. In one embodiment Applicants' invention provides a capacitive desalination apparatus including a first porous electrode conductor having first pores, a second porous electrode conductor having second pores, a film between the first porous electrode conductor and the second porous electrode conductor, a system for producing an applied electric field proximate the first porous electrode conductor and the second porous electrode conductor, and a system for flowing a target solution through the first pores and the second pores of the first porous electrode conductor and the second porous electrode conductor and the film. In another embodiment Applicants' invention provides a method of capacitive deionization, including the steps of providing a first porous electrode conductor having first pores, providing a second porous electrode conductor having second pores, providing a film between the first porous electrode conductor and the second porous electrode conductor, providing an applied electric field proximate the first porous electrode conductor and the second porous electrode conductor, and flowing a target solution through the first pores and the second pores of the first porous electrode conductor and the second porous electrode conductor and the film. Further, a second cell containing similar said electrodes and separator film is placed downstream and allows for a second stage to remove further salt. A system of recirculating brine allows for a very high water recovery ratio (desalinated volume/initial volume). Individual flow through cells can be arranged in series (to increase salt removal) or in parallel (to increase throughput).

Applicants' invention can be used in the desalination of sea and brackish water and in the process of creating purified water. It can also be used in the deionization of any aqueous stream, such as industrial waste water or residential sewage.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates a prior art capacitive deionization system wherein feed water flows through the gap between electrodes.

FIGS. 2A, 2B illustrate Applicants' “Flow-Through” system wherein electrodes are located so that a flow of feed water flows through the electrodes.

FIG. 3 is a graph show showing SEM and mercury intrusion porosimetry results.

FIGS. 4A, 4B, 4C, and 4D illustrate Applicants' prototype FTE-CD cell.

FIGS. 5A, 5B illustrate an alternative architecture in which feed water flow is instead parallel to the applied electric field

FIGS. 6A, 6B illustrate an alternative architecture in which feed water flow is through a spiral wound electrode

FIG. 7 illustrates possible staged systems involving serial staging for increasing salt removal from the feed water

FIG. 8 illustrates possible staged systems involving parallel staging for increasing salt processed water throughput

### DETAILED DESCRIPTION OF SPECIFIC EMBODIMENTS

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

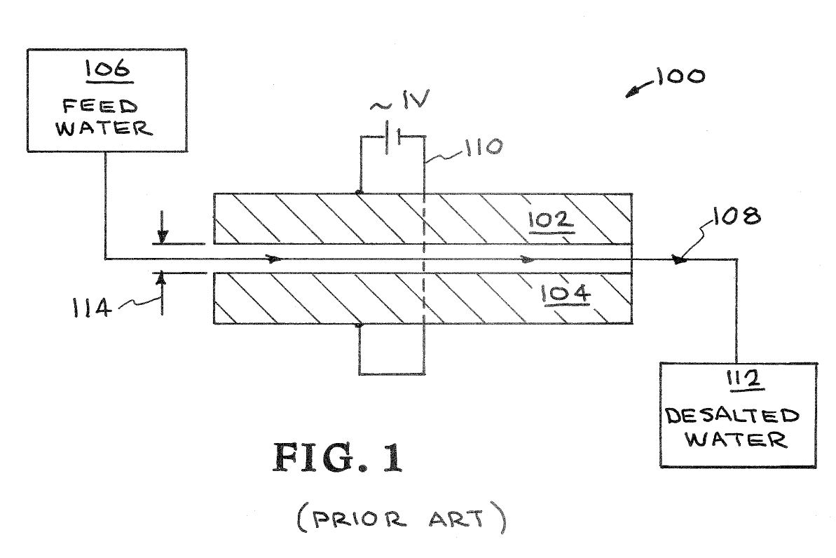

Referring now to the drawings and in particular to FIG. 1, a prior art system 100 is illustrated. In the prior art system 100 a pair of electrodes 102 and 104 are located in a flow of feed water 106 with the direction of flow illustrated by the arrow 108. An electrical circuit 110 energizes the electrodes 102 and 104 producing an electrical field acting on the feed water 106 producing desalted water 112. The flow 108 of feed water 106 enters the gap 114 and travels in a direction perpendicular to the applied electric field. The flow 108 of feed water 106 in the gap 114 is illustrated by the arrow 108. A permeable separator layer can be positioned in the gap 114 between the electrodes 102 and 104 to prevent electrical shorts between the electrodes.

The system 100 is a capacitive deionization system. The capacitive deionization system 100 is a process for the capacitive deionization (CDI) of water using electrodes developed by Lawrence Livermore National Laboratory. Aqueous solutions of Na2SO4, Na3PO₄, or Na2CO3 are passed through a stack of electrodes.

In the capacitive deionization system 100 ions are to be removed (referred to hereinafter as “feed water”) flows between electrodes 102 and 104 to which a potential difference is applied by the electrical circuit 110. As the feed water 106 flows through the gap 114 between the electrodes 102 and 104, ions within the water are attracted to respective electrodes: negative ions to the positively charged electrode and positive ions to the negatively charged electrode. More ions are removed from the water as it traverses the path between the electrodes 102 and 104, rendering the water purer and purer along the path. At some point, the electrodes 102 and 104 between which the water 106 passes become saturated with ions that have been removed from the feed water and adhere to the electrodes. When the electrodes 102 and 104 are saturated, the ions adhering to the electrodes 102 and 104 are flushed, thereby producing some water with a much higher concentration of ions. The deionized, or “purified,” water and brackish, or “concentrated,” water are separated; the purified water destined for use in any of a myriad of applications, including agricultural, drinking, industrial, the concentrated water for disposal.

This process is also capable of simultaneously removing a variety of other impurities. For example, dissolved heavy metals and suspended colloids can be removed by electrodeposition and electrophoresis, respectively. CDI has several potential advantages over other more conventional technologies. Unlike ion exchange, no acids, bases, or salt solutions are required for regeneration of the system. Regeneration is accomplished by electrically discharging the cell. Additional details of the capacitive deionization system 100 are provided in the publication, “Capacitive deionization of NaCl and NaNO3 solutions with carbon aerogels,” Farmer et al., J. Electrochem. Soc, 143, 1 (1996); also presented at the 27th International Society for the Advancement of Materials Process Engineers Technical Conference, Albuquerque, N. Mex., Oct. 9-12, 1995, which is incorporated herein in its entirety by this reference.

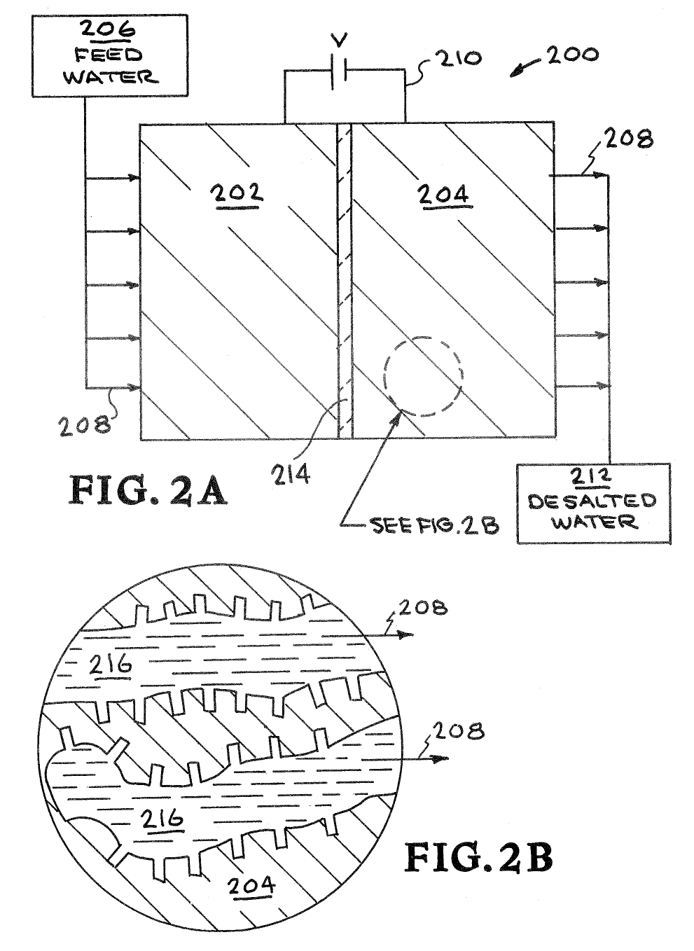

Referring now to FIGS. 2A and 2B, Applicants' “Flow Through” invention is illustrated by the system 200. The capacitive deionization system 200 is a process for the capacitive deionization (CDI) of water developed by Lawrence Livermore National Laboratory. In the system 200 a pair of electrodes 202 and 204 are located so that a flow of feed water 206, illustrated by the arrows 208, flows through the electrodes 202 and 204 and in the direction of the applied electric field. A porous, solid separator 114 made of a dielectric material to prevent electrical shorts, with thickness less than 20% the sum thickness of the electrodes is located between electrodes 202 and 204. The electrodes 202 and 204 include pores 216 through which the flow of feed water 206 flows. The micron scale pores 216 allow for fluid flow 206 directly through the electrode 204 while the nano-scale pores 216 provide high surface area for adsorption of ions. An electrical circuit 210 energizes the electrodes 202 and 204 producing an electrical field acting on the feed water 206 producing desalted water 212.

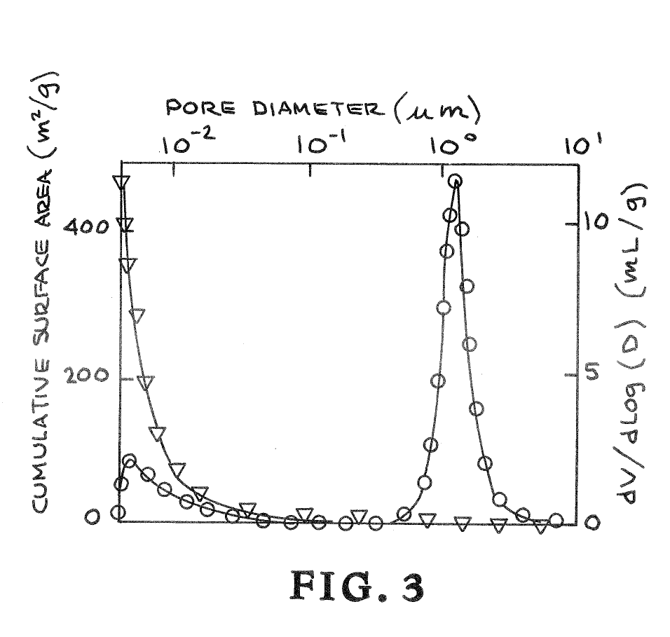

The system 200 is a capacitive deionization system using porous electrodes 202 and 204 in a flow-through configuration. The flow 208 through the electrodes 202 and 204 is parallel to the direction of the applied field created by the circuit 210, and thus the hydraulic resistance is that of both electrodes 202 and 204 in parallel. The electrodes used must have a network of micron-scale pores allowing for efficient fluidic transport and a large population of sub 50 nm pores to allow for high surface area and capacitance. Activated carbon aerogel materials are an example of this type of pore structure. This type of aerogel can reach an ultra high capacitance of over 100 F/g, and thus is appropriate towards the desalination of sea water. A graph is provided in FIG. 3 which shows: SEM and mercury intrusion porosimetry results show a hierarchical structure consisting of a narrow band of −1 μm pores, and sub-10 nm pores. Some of the benefits that are provided are:

1. Simultaneous high capacitance (>120 F/g) and low hydraulic resistance

2. Uniform micron-scale pore sizes, and tunable nano-scale pore sizes

3. Monolithic and mechanically strong

The electrodes 202 and 204 in a single cell will be separated by a porous, solid separator made of a dielectric material to prevent electrical shorts, and less than 100 microns thick. The electrodes may be affixed to a current collector of a metal, such as titanium. Thus, the cell structure (from positive wire to negative wire) is: a positively charged metal sheet current collector, a porous, positively charged electrode, a polymer spacer (<100 microns thick), the negative porous electrode, the negative current collector. A pump will push the target salt solution through the electrode pores, and will generate a pressure of less than order 100 kPa (several orders of magnitude less than required for reverse osmosis desalination of seawater). The desalination cycle will work as follows: the salt containing solution is pushed into an electrode pair segment with no adsorbed ions. A voltage of less than 2 V is applied to remove ions from the water and adsorb them onto the electrode, and to avoid Faradaic reactions. The desalinated volume is pumped out of the electrode segment and replaced with an equal volume of untreated salt water. Then, the voltage is removed from the electrodes and the ions desorb from the electrodes into the untreated water to regenerate the electrode surface, and the brine is then pumped from the cell and replaced with the next batch of water to be desalinated. The system can be operated with many serial and/or parallel cells to allow for high throughput, staged desalination of sea water. Further, alternating desalinated and brine water batches which flow through the electrode system can be separated from each other by several fluids, such as air, other gases or any immiscible liquids. The system can also run with no separating fluid by ensuring the residence time of water in the system is much less than the diffusion time across a water batch.

Further, brine can be recirculated through the system to continue to adsorb charge for several charge/discharge cycles. This method takes advantage of the fact that the solubility of sodium chloride in water is about one order of magnitude higher than the salt concentration of seawater. Thus, brine can be recirculated and used several times to adsorb charge during the regeneration step before the fluid is saturated. This increases the percentage of desalinated water volume to initial water volume to over 80-90%, well above the water recovery rates of reverse osmosis (typically about 40%).

Background

Capacitive deionization is a promising water desalination technique, as it operates at sub-osmotic pressures, requires minimal balance of plant, and can be fabricated with inexpensive and robust electrodes. Previous CDI techniques achieved limited success, and these involved: 1) flowing a salt stream between two monolithic porous electrodes (denoted a “flow between” technique), where the electrodes were typically separated by a millimeter or more, and were impermeable to flow due to sub 50-nm pores, or 2) by flowing a salt stream through packed beds of carbon particles and porous separators, with flow in the direction of applied electric field. The latter method corresponds one of the earliest developed CDI systems, and suffered from low electrode mechanical stability, low solid phase conductivity, and high required pressures associated with flowing in the direction of applied field. The former method allowed for higher electrode stability, conductivity, and lower pressures, yet also resulted in lower desalination efficiencies and thus required larger volumes of electrode material and higher energy costs. Both these techniques were only able to desalinate low salinity streams (typically order 1000 ppm TDS, or lightly brackish water), required long desalination times and were energy intensive compared to state of the art desalination, such as reverse osmosis. In Applicants' proposed system, we will flow salt water through a monolithic electrode with a macropore network, and flow will be parallel to applied field. Applicants' flow through capacitive desalination technique is the first to combine the mechanical stability of monolithic electrodes, and the energy efficiency and fast desalination times of a flow through configuration. Also, by carefully tuning the flow through pore diameter, the system can operate at pressures several orders under that of the osmotic pressure, and thus the energy lost to pumping is a negligible fraction of the energy required to separate ions.

Applicants' technique also overcomes the limitations of previous CDI systems in desalinating high salinity streams (namely sea water). In flow between CDI of high salt streams, desalination is primarily driven to slow salt diffusion from the target stream into depleted electrode pores. By flowing through electrodes, Applicants' technique reduces time required for desalination by over an order of magnitude. Second, we can now use all of the available surface sites for storage of useful salt. In flow between CDI systems, the salt ions initially present in uncharged electrode pores occupy surface sites on the charged surface, reducing the sites available for ions from the target flow. Third, by limiting the distance between electrodes to less than 20% of the sum thickness of the electrodes, both cell electrical resistance, energy requirements, and RC charge times can be significantly reduced. Finally, previous flow through systems utilized electrode materials with low specific surface area and capacitance when compared to, for example, recently developed activated carbon aerogels electrodes. Thus prior art flow through systems were are unable to desalinate high salinity feedwater.

### EXAMPLES

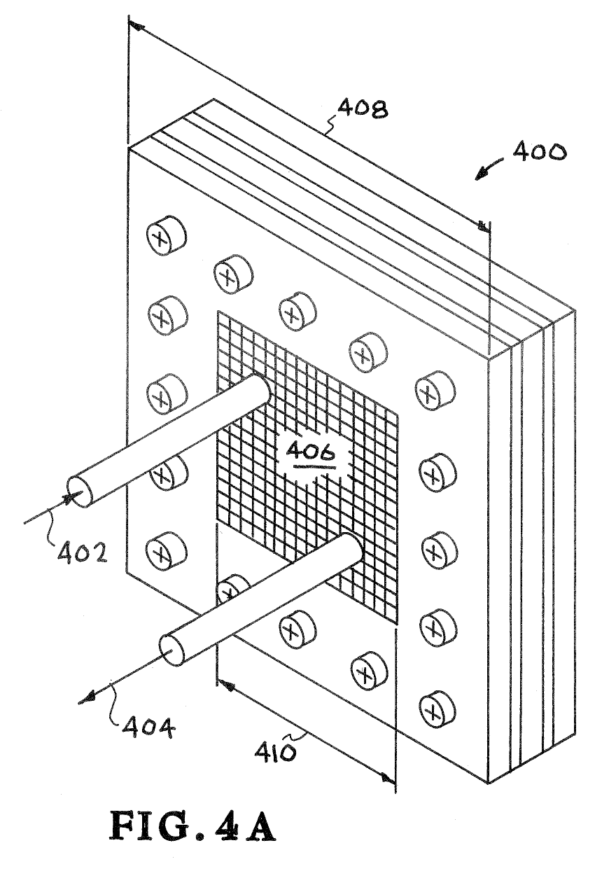

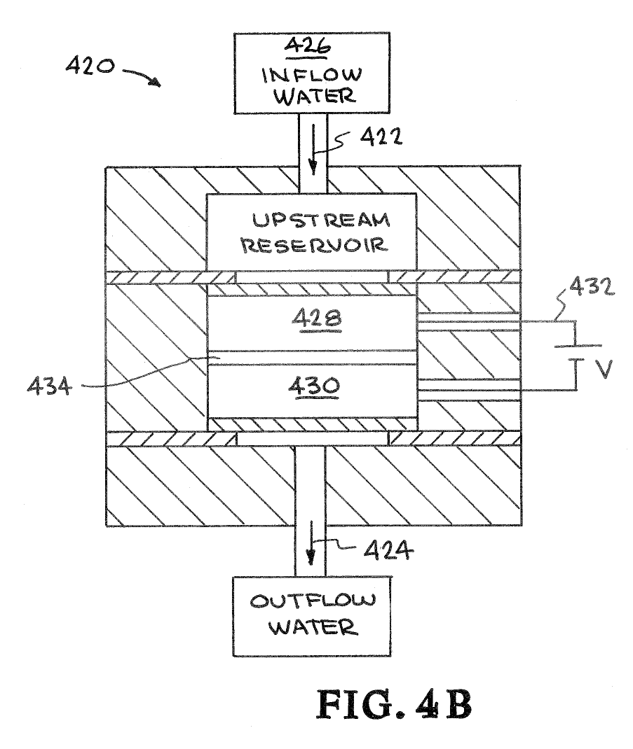

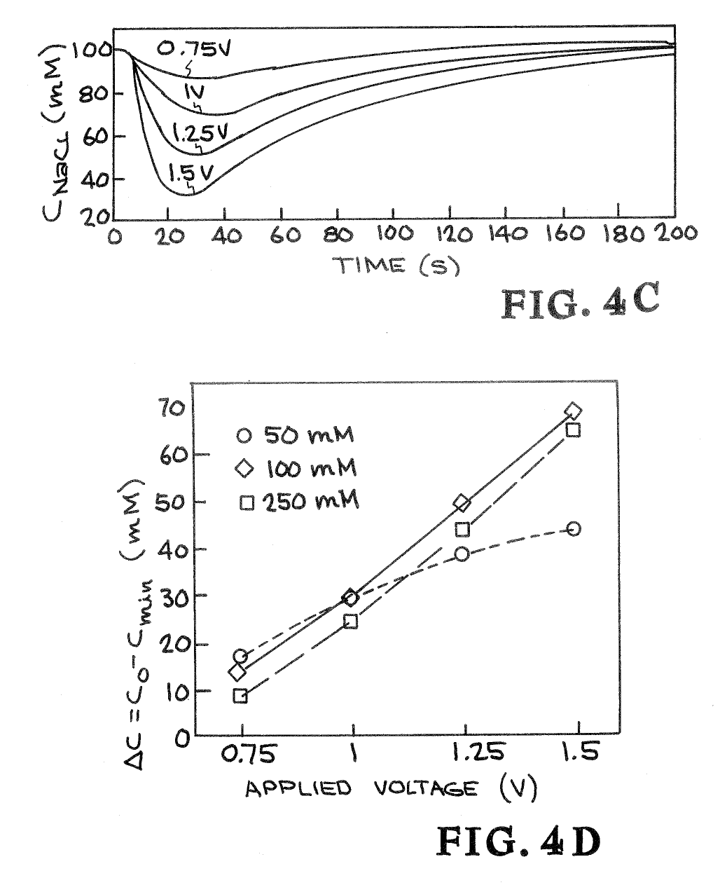

Referring now to FIGS. 4A, 4B, 4C, 4D, and 4E Applicants have built and tested prototype FTE-CD cells with 0.8 cc (0.26 g) of hierarchical carbon aerogel electrode material. FIGS. 4A and 4B illustrate one of the prototype cells. The cell is designated generally by the reference numeral 400 in FIG. 4A. Flow lines 402 and 404 provide flow of water into and out of the cell 400. The electrodes are indicated by the reference numeral 406. The cell 400 has a width of 4 cm as indicated by the arrows 408. The electrodes component 406 has a width of 1.7 cm as indicated by the arrows 410.

FIG. 4B is an illustration of a prototype cell designated generally by the reference numeral 420. The arrows 422 and 424 illustrate the flow of water 426 into and out of the cell 420. The water 426 flows through electrodes 428 and 430 to which a potential difference is applied by the electrical circuit 432. A porous, solid separator 434 is located between electrodes 428 and 430. As the water 406 flows through the electrodes 428 and 430, ions within the water 426 are attracted to respective electrodes: negative ions to the positively charged electrode and positive ions to the negatively charged electrode. More ions are removed from the water as it traverses the path through the electrodes 428 and 430, rendering the water purer and purer along the path. At some point, the electrodes 428 and 430 through which the water 426 passes become saturated with ions that have been removed from the feed water and adhere to the electrodes. When the electrodes 428 and 430 are saturated, the ions adhering to the electrodes 428 and 430 are flushed, thereby producing some water with a much higher concentration of ions.

FIG. 4C is a graph that illustrates the concentration of water extracted from charged aerogel pores versus time. Flowrate is 0.5 mL/min. Up to 70 mM concentration reduction obtained by one of the prototype cells. FIG. 4D is a graph that illustrates measured concentration reduction of extracted water versus voltage for one of the prototype cells.

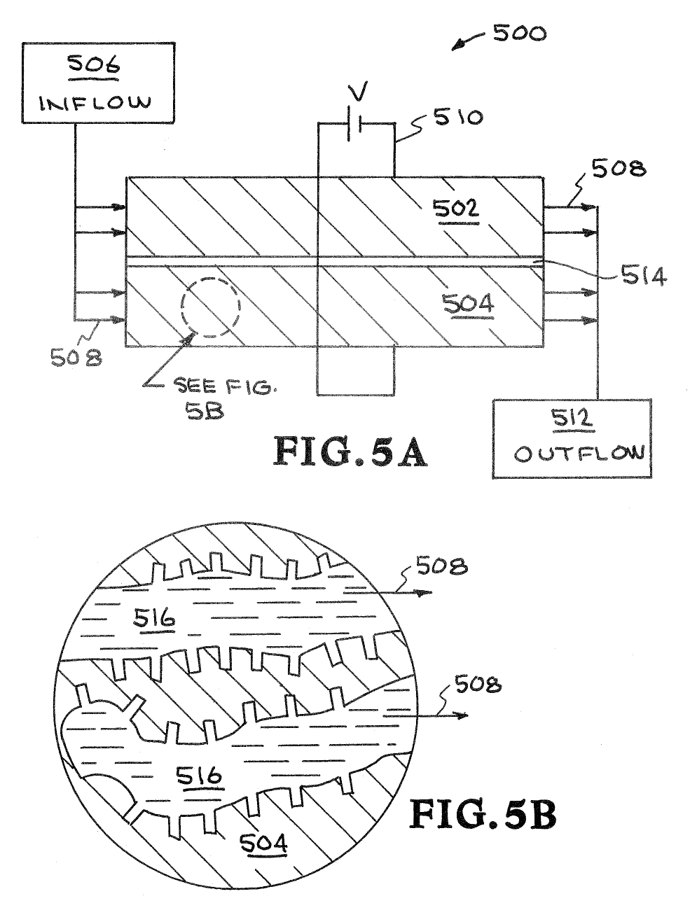

Referring now to FIGS. 5A and 5B, another embodiment of Applicants' “Flow Through” invention is illustrated by the system 500. This embodiment of Applicants' “Flow Through” invention is a system 500 that provides flow perpendicular to the applied field. An electrical circuit 510 energizes the electrodes 502 and 504 and produces an electrical field acting on the feed water 506 producing desalted water 512. In the system 500 a pair of electrodes 502 and 504 are located so that a flow of feed water 506, illustrated by the arrows 508, flows through the electrodes 502 and 504 and perpendicular to the applied electric field. A porous, solid separator 114 made of a dielectric material to prevent electrical shorts, and less than 20% the sum thickness of the electrodes is located between electrodes 502 and 504. The electrodes 502 and 504 include pores 516 through which the flow of feed water 506 flows. The micron scale pores 516 allow for fluid flow 506 directly through the electrode 504 while the nano-scale pores 516 provide high surface area for adsorption of ions.

The system 500 is a capacitive deionization system using porous electrodes 502 and 504 in a flow-through configuration. The electrodes have a network of micron-scale pores allowing for efficient fluidic transport and a large population of sub 50 nm pores to allow for high surface area and capacitance. Activated carbon aerogel, materials are an example of this type of pore structure. This type of aerogel can reach an ultra high capacitance of over 100 F/g, and thus is appropriate towards the desalination of sea water.

The electrodes 502 and 504 in a single cell are separated by a porous, solid separator 514 made of a dielectric material to prevent electrical shorts, and less than 100 microns thick. The electrodes may be affixed to a current collector of a metal, such as titanium. Thus, the cell structure (from positive wire to negative wire) is: a positively charged metal sheet current collector, a porous, positively charged electrode, a polymer spacer (<100 microns thick), the negative porous electrode, the negative current collector. A pump will push the target salt solution through the electrode pores, and will generate a pressure of less than order 100 kPa (several orders of magnitude less than required for reverse osmosis desalination of seawater). The desalination cycle will work as follows: the salt containing solution is pushed into an electrode pair segment with no adsorbed ions. A voltage of less than 2 V is applied to remove ions from the water and adsorb them onto the electrode, and to avoid Faradaic reactions. The desalinated volume is pumped out of the electrode segment and replaced with an equal volume of untreated salt water. Then, the voltage is removed from the electrodes and the ions desorb from the electrodes into the untreated water to regenerate the electrode surface, and the brine is then pumped from the cell and replaced with the next batch of water to be desalinated. The system can be operated with many serial and/or parallel cells to allow for high throughput, staged desalination of sea water. Further, alternating desalinated and brine water batches which flow through the electrode system can be separated from each other by several fluids, such as air, other gases or any immiscible liquids. The system can also run with no separating fluid by ensuring the residence time of water in the system is much less than the diffusion time across a water batch.

Further, brine can be recirculated through the system to continue to adsorb charge for several charge/discharge cycles. This method takes advantage of the fact that the solubility of sodium chloride in water is about one order of magnitude higher than the salt concentration of seawater. Thus, brine can be recirculated and used several times to adsorb charge during the regeneration step before the fluid is saturated. This increases the percentage of desalinated water volume to initial water volume to over 80-90%, well above the water recovery rates of reverse osmosis (typically about 40%).

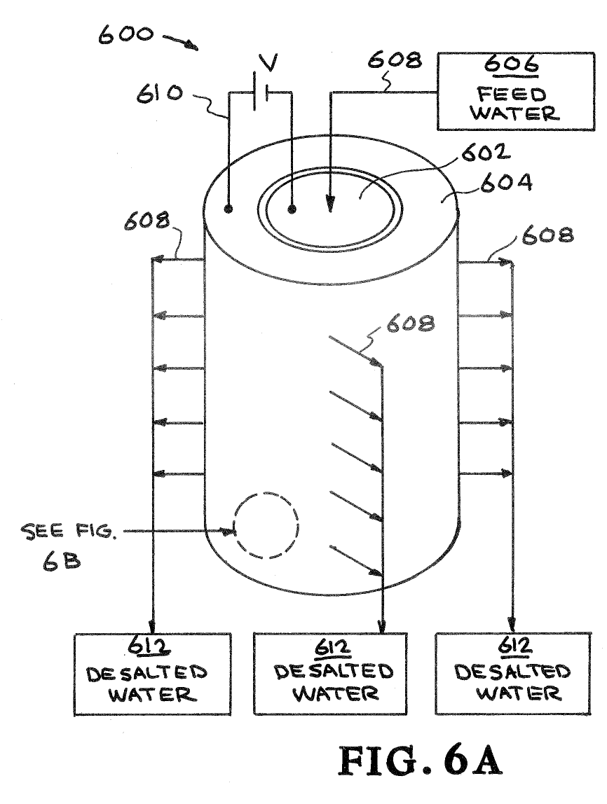

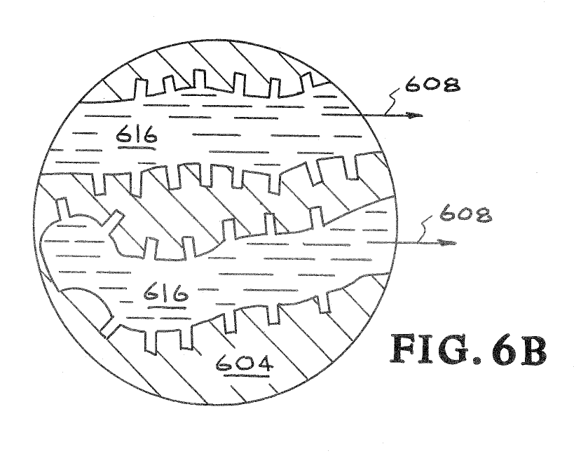

Referring now to FIGS. 6A and 6B, yet another embodiment of Applicants' “Flow Through” invention is illustrated by the system 600. This embodiment of Applicants' “Flow Through” invention is a system 600 that having spiral wound electrodes 602 and 604. An electrical circuit 610 energizes the electrodes 602 and 604 and produces an electrical field acting on the feed water 606 producing desalted water 612. In the system 600 the pair of electrodes 602 and 604 are spiral wound and located so that a flow of feed water 606, illustrated by the arrows 608, flows through the electrodes 602 and 604 and through the applied electric field. A porous, solid separator 114 made of a dielectric material to prevent electrical shorts, and less than 20% the sum thickness of the electrodes is located between electrodes 602 and 604. The electrodes 602 and 604 include pores 616 through which the flow of feed water 606 flows. The micron scale pores 616 allow for fluid flow 606 directly through the electrode 604 while the nano-scale pores 616 provide high surface area for adsorption of ions.

The system 600 is a capacitive deionization system using spiral wound porous electrodes 602 and 604 in a flow-through configuration. The inflow of feed water 606 is through the center of spiral wound electrode 602. The outflow of desalted water 612 is thorough the outer surface of the spiral wound electrode 604. The electrodes have a network of micron-scale pores allowing for efficient fluidic transport and a large population of sub 50 nm pores to allow for high surface area and capacitance. Activated carbon aerogel, materials are an example of this type of pore structure. This type of aerogel can reach an ultra high capacitance of over 100 F/g, and thus is appropriate towards the desalination of sea water.

The electrodes 602 and 604 in a single cell are separated by a porous, solid separator 614 made of a dielectric material to prevent electrical shorts, and less than 100 microns thick. The electrodes may be affixed to a current collector of a metal, such as titanium. Thus, the cell structure (from positive wire to negative wire) is: a positively charged metal sheet current collector, a porous, positively charged electrode, a polymer spacer (<100 microns thick), the negative porous electrode, the negative current collector. A pump will push the target salt solution through the electrode pores, and will generate a pressure of less than order 100 kPa (several orders of magnitude less than required for reverse osmosis desalination of seawater). The desalination cycle will work as follows: the salt containing solution is pushed into an electrode pair segment with no adsorbed ions. A voltage of less than 2 V is applied to remove ions from the water and adsorb them onto the electrode, and to avoid Faradaic reactions. The desalinated volume is pumped out of the electrode segment and replaced with an equal volume of untreated salt water. Then, the voltage is removed from the electrodes and the ions desorb from the electrodes into the untreated water to regenerate the electrode surface, and the brine is then pumped from the cell and replaced with the next batch of water to be desalinated. The system can be operated with many serial and/or parallel cells to allow for high throughput, staged desalination of sea water. Further, alternating desalinated and brine water batches which flow through the electrode system can be separated from each other by several fluids, such as air, other gases or any immiscible liquids. The system can also run with no separating fluid by ensuring the residence time of water in the system is much less than the diffusion time across a water batch.

Further, brine can be recirculated through the system to continue to adsorb charge for several charge/discharge cycles. This method takes advantage of the fact that the solubility of sodium chloride in water is about one order of magnitude higher than the salt concentration of seawater. Thus, brine can be recirculated and used several times to adsorb charge during the regeneration step before the fluid is saturated. This increases the percentage of desalinated water volume to initial water volume to over 80-90%, well above the water recovery rates of reverse osmosis (typically about 40%).

Arrays of Flow Through Capacitive Deionization Systems

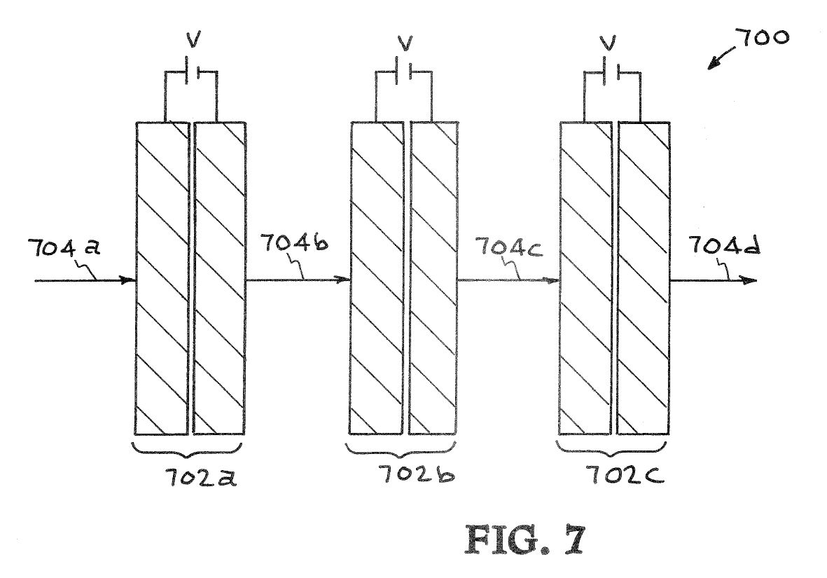

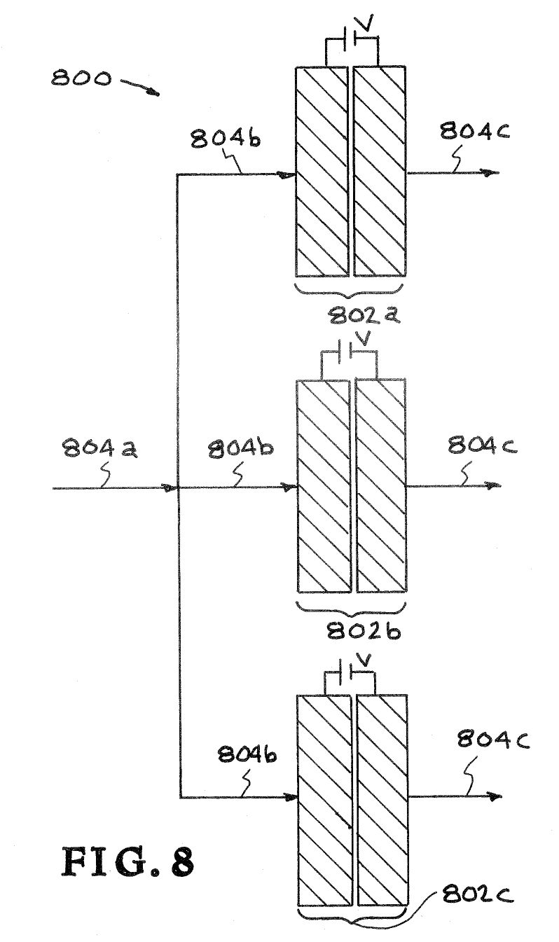

Referring now to FIGS. 7 and 8, arrays of Applicants' “Flow Through” invention are illustrated by the systems 700 and 800. The system 700 illustrated in FIG. 7 shows a multiplicity of individual “Flow Through” capacitive deionization systems in series. By arranging a multiplicity of flow through capacitive deionization systems in series the amount of water that can be processed and purity of the desalted water is increased. As shown in FIG. 7, the flow of feed water, illustrated by the arrow 704a, flows into and through the first flow through capacitive deionization system 702a. The purified flow of feed water, illustrated by the arrow 704b, from the first flow through capacitive deionization system 702a flows into and through the second flow through capacitive deionization system 702b. In the next stage, the purified flow of feed water, illustrated by the arrow 704c, from the second flow through capacitive deionization system 702b flows into and through the third flow through capacitive deionization system 702c, Purified flow of feed water, illustrated by the arrow 704d, from the third flow through capacitive deionization system 702c can be directed to additional flow through capacitive deionization systems. The system 700 can be operated with many serial cells to allow for high throughput, staged desalination of sea water.

The system 800 illustrated in FIG. 8 shows a multiplicity of individual “Flow Through” capacitive deionization systems in parallel. By arranging a multiplicity of flow through capacitive deionization systems in parallel the amount of water that can be processed is increased significantly. As shown in FIG. 3, the flow of feed water, illustrated by the arrow 804a, is channeled so that it flows into and through a multiplicity of flow through capacitive deionization systems. The purified flow of feed water, illustrated by arrow 804b, flows into and through the first flow through capacitive deionization system 802a. Simultaneously, the flow of feed water, illustrated by arrow 804b, flows into and through the second flow through capacitive deionization system 802b. Simultaneously, the flow of feed water, illustrated by arrow 804b, flows into and through the third flow through capacitive deionization system 802c. Purified flow of feed water, illustrated by the arrows 804c, from the flow through capacitive deionization systems 802a, 802b, and 802c emerges and can be further processed or used. The purified flow of feed water, illustrated by the arrows 804c, can be directed to additional flow through capacitive deionization systems in series as illustrated in FIG. 7 or additional flow through capacitive deionization systems in parallel as illustrated in FIG. 8. The systems 700 and 800 can be operated with many serial and/or parallel cells to allow for high throughput, staged desalination of sea water.

Additional details of the invention are described in the Poster titled “Electrode flow-through capacitive desalination” presented by Matthew E. Suss, Theodore F. Baumann, Juan G. Santiago, and Michael Stadermann Oct. 25, 2011 at Lawrence Livermore National Laboratory. The Poster titled “Electrode flow-through capacitive desalination” presented by Matthew E. Suss, Theodore F. Baumann, Juan G. Santiago, and Michael Stadermann Oct. 25, 2011 at Lawrence Livermore National Laboratory is incorporated in this application in its entirety for all purposes by this reference.

The water desalination system and method described above that incorporates various principles of the present invention employs a combination of capacitive deionization with fluid flow directly through the electrode material to, respectively, remove ions from feed water and extract desalted water from the system. In illustrative embodiments, water is desalinated using capacitive deionization in conjunction with flow through the micron-scale pores of a hierarchically structured electrode material. In such an illustrative embodiment, the dielectric separator layer between electrodes has a minimized thickness (in the electric field direction), that is less than 40% the thickness of an electrode.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A capacitive desalination apparatus for removing salt from a target salt solution, comprising:
a first porous electrode conductor having first pores,
a second porous electrode conductor having second pores,
a non-conducting permeable spacer between said first porous electrode conductor and said second porous electrode conductor,
a system for applying an electric potential difference between said first porous electrode conductor, and said second porous electrode conductor, thereby removing at least a portion of the salt from the target salt solution, and
a system for flowing the target salt solution
through first porous electrode conductor having first pores,
through said non-conducting permeable spacer, and
through said second porous electrode conductor having second pores thereby extracting at least a portion of the desalted target salt solution.

2. The capacitive desalination apparatus for removing salt from a target salt solution of claim 1 wherein said non-conducting permeable spacer has a width that is less than 100 μm thick.

3. The capacitive desalination apparatus for removing salt from a target salt solution of claim 1 wherein said non-conducting permeable spacer has a width and said width is between 20 μm and 100 μm.

4. The capacitive desalination apparatus for removing salt from a target salt solution of claim 1 wherein said first porous electrode conductor has a first electrode conductor width and wherein said non-conducting permeable spacer has a width that is less forty percent of said first electrode conductor width.

5. The capacitive desalination apparatus for removing salt from a target salt solution of claim 4 wherein said second porous electrode conductor has a second electrode conductor width and wherein said non-conducting permeable spacer has a width that is less forty percent of said second electrode conductor width.

6. The capacitive desalination apparatus for removing salt from a target salt solution of claim 1 wherein said first pores of said first porous electrode conductor having first pores comprise transport pores with diameter greater than 500 nm for effecting transport of the target salt solution and adsorption pores with diameter less than 100 nm for effecting adsorption of the salt from the target salt solution.

7. The capacitive desalination apparatus for removing salt from a target salt solution of claim 1 wherein said first porous electrode conductor having first pores is made of carbon.

8. The capacitive desalination apparatus for removing salt from a target salt solution of claim 1 wherein said second porous electrode conductor having second pores is made of carbon.

9. The capacitive desalination apparatus for removing salt from a target salt solution of claim 1 wherein said first porous electrode conductor having first pores is made of carbon and wherein said second porous electrode conductor having second pores is made of carbon.

10. The capacitive desalination apparatus for removing salt from a target salt solution of claim 1 wherein said first porous electrode conductor having first pores is made of carbon aerogel.

11. The capacitive desalination apparatus for removing salt from a target salt solution of claim 1 wherein said first porous electrode conductor having first pores and said second porous electrode conductor having second pores are made of carbon aerogel.

12. The capacitive desalination apparatus for removing salt from a target salt solution of claim 1 wherein said system for flowing the target salt solution through first porous electrode conductor, through said non-conducting permeable spacer, and through said second porous electrode conductor provides a target salt solution flow; and wherein said system for applying an electric potential difference between said first porous electrode conductor and said second porous electrode conductor produces and electric field that is perpendicular to said target salt solution flow.

13. The capacitive desalination apparatus for removing salt from a target salt solution of claim 1 wherein said system for flowing the target salt solution through first porous electrode conductor, through said non-conducting permeable spacer, and through said second porous electrode conductor provides a target salt solution flow; and wherein said system for applying an electric potential difference between said first porous electrode conductor and said second porous electrode conductor produces and electric field that is parallel to said target salt solution flow.

14. The capacitive desalination apparatus for removing salt from a target salt solution of claim 1 wherein said a first porous electrode conductor having first pores, a second porous electrode conductor having second pores, a non-conducting permeable spacer between said first porous electrode conductor and said second porous electrode conductor are spiral wound.

15. The capacitive desalination apparatus for removing salt from a target salt solution of claim 1 further comprising additional units of capacitive desalination apparatus for removing salt from a target salt solution wherein said additional units of capacitive desalination apparatus comprise a first porous electrode conductor having first pores, a second porous electrode conductor having second pores, a non-conducting permeable spacer between said first porous electrode conductor and said second porous electrode conductor, a system for applying an electric potential difference between said first porous electrode conductor, and said second porous electrode conductor, thereby removing at least a portion of the salt from the target salt solution, and a system for flowing the target salt solution through first porous electrode conductor having first pores, through said non-conducting permeable spacer, and through said second porous electrode conductor having second pores thereby extracting at least a portion of the desalted target salt solution.

16. The capacitive desalination apparatus for removing salt from a target salt solution of claim 1 further comprising additional units of capacitive desalination apparatus for removing salt from a target salt solution wherein said additional units of capacitive desalination apparatus comprise a first porous electrode conductor having first pores, a second porous electrode conductor having second pores, a non-conducting permeable spacer between said first porous electrode conductor and said second porous electrode conductor, a system for applying an electric potential difference between said first porous electrode conductor, and said second porous electrode conductor, thereby removing at least a portion of the salt from the target salt solution, and a system for flowing the target salt solution through first porous electrode conductor having first pores, through said non-conducting permeable spacer, and through said second porous electrode conductor having second pores thereby extracting at least a portion of the desalted target salt solution connected in series.

17. The capacitive desalination apparatus for removing salt from a target salt solution of claim 1 further comprising additional units of capacitive desalination apparatus for removing salt from a target salt solution wherein said additional units of capacitive desalination apparatus comprise a first porous electrode conductor having first pores, a second porous electrode conductor having second pores, a non-conducting permeable spacer between said first porous electrode conductor and said second porous electrode conductor, a system for applying an electric potential difference between said first porous electrode conductor, and said second porous electrode conductor, thereby removing at least a portion of the salt from the target salt solution, and a system for flowing the target salt solution through first porous electrode conductor having first pores, through said non-conducting permeable spacer, and through said second porous electrode conductor having second pores thereby extracting at least a portion of the desalted target salt solution connected in parallel.

18. The capacitive desalination apparatus for removing salt from a target salt solution of claim 1 further comprising additional units of capacitive desalination apparatus for removing salt from a target salt solution wherein said additional units of capacitive desalination apparatus comprise a first porous electrode conductor having first pores, a second porous electrode conductor having second pores, a non-conducting permeable spacer between said first porous electrode conductor and said second porous electrode conductor, a system for applying an electric potential difference between said first porous electrode conductor, and said second porous electrode conductor, thereby removing at least a portion of the salt from the target salt solution, and a system for flowing the target salt solution through first porous electrode conductor having first pores, through said non-conducting permeable spacer, and through said second porous electrode conductor having second pores thereby extracting at least a portion of the desalted target salt solution connected in series and in parallel.

19. A capacitive desalination apparatus for removing salt from a target salt solution, comprising:
a first porous electrode conductor having first pores,
a second porous electrode conductor having second pores,
a non-conducting permeable spacer between said first porous electrode conductor and said second porous electrode conductor,
a system for applying an electric potential difference between said first porous electrode conductor, and said second porous electrode conductor, thereby removing at least a portion of the salt from the target salt solution, and
means for flowing the target salt solution
through first porous electrode conductor having first pores,
through said non-conducting permeable spacer, and
through said second porous electrode conductor having second pores thereby extracting at least a portion of the desalted target salt solution.

20. The capacitive desalination apparatus for removing salt from a target salt solution of claim 19 wherein said non-conducting permeable spacer has a width that is less than 100 μm thick.

21. The capacitive desalination apparatus for removing salt from a target salt solution of claim 19 wherein said non-conducting permeable spacer has a width and said width is between 20 μm and 100 μm.

22. The capacitive desalination apparatus for removing salt from a target salt solution of claim 19 wherein said first porous electrode conductor has a first electrode conductor width and wherein said non-conducting permeable spacer has a width that is less forty percent of said first electrode conductor width.

23. The capacitive desalination apparatus for removing salt from a target salt solution of claim 22 wherein said second porous electrode conductor has a second electrode conductor width and wherein said non-conducting permeable spacer has a width that is less forty percent of said second electrode conductor width.

24. The capacitive desalination apparatus for removing salt from a target salt solution of claim 19 wherein said first pores of said first porous electrode conductor having first pores comprise transport pores with diameter greater than 500 nm for effecting transport of the target salt solution and adsorption pores with diameter less than 100 nm for effecting adsorption of the salt from the target salt solution.

25. The capacitive desalination apparatus for removing salt from a target salt solution of claim 19 wherein said first porous electrode conductor having first pores is made of carbon aerogel.

26. The capacitive desalination apparatus for removing salt from a target salt solution of claim 19 wherein said first porous electrode conductor having first pores and said second porous electrode conductor having second pores are made of carbon aerogel.

27. A capacitive desalination apparatus for removing salt from a target salt solution, comprising:
a first porous monolithic electrode conductor having first pores,
a second porous monolithic electrode conductor having second pores,
a non-conducting permeable spacer between said first porous monolithic electrode conductor and said second porous monolithic electrode conductor,
a system for applying an electric potential difference between said first porous monolithic electrode conductor, and said second porous monolithic electrode conductor, thereby removing at least a portion of the salt from the target salt solution, and
a system for flowing the target salt solution
through first porous monolithic electrode conductor having first pores,
through said non-conducting permeable spacer, and
through said second porous monolithic electrode conductor having second pores thereby extracting at least a portion of the desalted target salt solution.

28. A method of capacitive desalination for removing salt from a target salt solution, comprising the steps of:
providing a first porous electrode conductor having first pores,
providing a second porous electrode conductor having second pores,
providing a non-conducting permeable spacer between said first porous electrode conductor and said second porous electrode conductor,
applying an electric field between said first porous electrode conductor and said second porous electrode conductor utilizing said first porous electrode conductor and said second porous electrode conductor, and
flowing the target salt solution through said first pores of said first porous electrode conductor, said second pores of said second porous electrode conductor, and said film for extracting the target salt solution.

29. The method of capacitive desalination for removing salt from a target salt solution of claim 28 wherein said step of providing a non-conducting permeable spacer between said first porous electrode conductor and said second porous electrode conductor comprises providing a non-conducting permeable spacer that has a width and said width is less than 100 μm thick between said first porous electrode conductor and said second porous electrode conductor.

30. The method of capacitive desalination for removing salt from a target salt solution of claim 28 wherein said step of providing a first porous electrode conductor having first pores comprises providing a first porous electrode conductor having first pores wherein said first pores include transport pores with diameter greater than 500 nm for effecting transport of the target salt solution and adsorption pores with diameter less than 100 nm for effecting adsorption of the salt from the target salt solution.

31. The method of capacitive desalination for removing salt from a target salt solution of claim 28 wherein said step of providing a first porous electrode conductor having first pores comprises providing a first porous electrode conductor made of carbon.

32. The method of capacitive desalination for removing salt from a target salt solution of claim 28 wherein said step of providing a first porous electrode conductor having first pores comprises providing a first porous electrode conductor made of carbon aerogel.

33. The method of capacitive desalination for removing salt from a target salt solution of claim 28 wherein said step of providing a first porous electrode conductor having first pores comprises providing a first porous electrode conductor made of carbon aerogel and wherein said step of providing a second porous electrode conductor having second pores comprises providing a second porous electrode conductor made of carbon aerogel.
